(19) United States
(12) Patent Application Publication
(10) Pub. No.: US 2017/0111574 A1
(43) Pub. Date: Apr. 20, 2017

(54) IMAGING APPARATUS AND IMAGING METHOD

(71) Applicant: OLYMPUS CORPORATION, Tokyo (JP)

(72) Inventor: Naoyuki MIYASHITA, Tokorozawa-shi (JP)

(73) Assignee: OLYMPUS CORPORATION, Tokyo (JP)

(21) Appl. No.: 15/391,665

(22) Filed: Dec. 27, 2016

Related U.S. Application Data
(63) Continuation of application No. PCT/JP2015/063874, filed on May 14, 2015.

(30) Foreign Application Priority Data
Jun. 30, 2014 (JP) 2014-134529

(51) Int. Cl. H04N 5/232

(52) U.S. Cl. CPC H04N 5/23222; H04N 5/23216; H04N 5/23293; H04N 5/23251

(57) ABSTRACT

An imaging apparatus includes an imaging circuit, a display, an operation interface, and a controller. The imaging circuit acquires image data from a subject image. The display displays an image based on the image data. The operation interface provides an instruction to the imaging apparatus. The controller causes the display to display a live view image based on image data acquired as live view image data by the imaging circuit, causes, when a first instruction serving as the instruction is provided from the operation interface, the imaging circuit to acquire the image data as first photographed image data, generates at least one piece of model image data based on the first photographed image data, generates guide information based on the generated model image data, and causes the display to display the generated guide information together with the live view image.

### CROSS-REFERENCE TO RELATED APPLICATIONS

This application is a Continuation application of PCT Application No. PCT/JP2015/063874, filed May 14, 2015 and based upon and claiming the benefit of priority from the prior Japanese Patent Application No. 2014-134529, filed Jun. 30, 2014, the entire contents of both of which are incorporated herein by reference.

### BACKGROUND OF THE INVENTION

1. Field of the Invention

The present invention relates to an imaging apparatus presenting proper content to the user to support an imaging action of the user, and an imaging method using the same.

2. Description of the Related Art

In recent years, imaging apparatuses having a function of assisting the user in setting composition in imaging have been proposed. For example, the display control apparatus disclosed in the specification of US Patent Application Publication No. 2013/0293746 is configured to generate a plurality of pieces of assistant image data with compositions different from each other, based on the original image data stored in a frame memory as a result of imaging, and cause a display to display a plurality of assistant images based on the generated assistant image data. In addition, the display control apparatus disclosed in the specification of US Patent Application Publication No. 2013/0293746 is configured to display arrows indicating moving directions of the imaging circuit required for the user's imaging the individual assistant images. The imaging apparatus disclosed in Japanese Patent Application KOKAI Publication No. 2013-183306 is configured to recognize the main subject and other subjects in a live image acquired as a result of imaging, and sense a composition frame to achieve a composition satisfying a predetermined composition condition based on the positional relation between the recognized main subject and the other subjects, the areas occupied by the respective subjects, and the radio of the occupied areas thereof. The imaging apparatus disclosed in Japanese Patent Application KOKAI Publication No. 2013-183306 is also configured to display, on the live image, a movement mark indicating the moving direction of the imaging apparatus to achieve the predetermined composition condition, when a composition frame can be sensed.

### BRIEF SUMMARY OF THE INVENTION

According to a first aspect of the invention, an imaging apparatus comprises: an imaging circuit configured to acquire image data from a subject image; a display configured to display an image based on the image data; an operation interface configured to provide an instruction to the imaging apparatus; and a controller configured to cause the display to display a live view image based on image data acquired as live view image data by the imaging circuit, cause, when a first instruction serving as the instruction is provided from the operation interface, the imaging circuit to acquire the image data as first photographed image data, generate at least one piece of model image data based on the first photographed image data, generating guide information based on the generated model image data, and cause the display to display the generated guide information together with the live view image.

According to a second aspect of the invention, an imaging method comprises: acquiring image data from a subject image with an imaging circuit; causing a display to display a live view image based on image data acquired as live view image data with the imaging circuit; causing the imaging circuit to acquire the image data as first photographed image data, when a first instruction is provided from an operation interface; generating at least one piece of model image data based on the first photographed image data; generating guide information based on the model image data; and causing the display to display the guide information together with the live view image.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a configuration serving as an example of an imaging apparatus according to embodiments of the present invention;

FIG. 2 is an external view of the imaging apparatus serving as the example;

FIG. 3 is a flowchart illustrating a process of an imaging method according to a first embodiment;

FIG. 4 is a diagram illustrating an example of check during a composition guide mode;

FIG. 5 is a diagram illustrating an example of a desired composition;

FIG. 6A is a first view illustrating a concept of change of the composition;

FIG. 6B is a second view illustrating the concept of change of the composition;

FIG. 6C is a third view illustrating the concept of change of the composition;

FIG. 6D is a fourth view illustrating the concept of change of the composition;

FIG. 7 is a diagram illustrating an example of the composition determined by the user prior to imaging of a first photographed image;

FIG. 8 is a diagram illustrating a concept of generation of model image data;

FIG. 9A is a first view illustrating an example of the model image data;

FIG. 9B is a second view illustrating an example of the model image data;

FIG. 9C is a third view illustrating an example of the model image data;

FIG. 9D is a fourth view illustrating an example of the model image data;

FIG. 10 is a diagram illustrating a display example of the first photographed image and model images;

FIG. 11 is a diagram illustrating a display example at the time when a model image is selected;

FIG. 12A is a first view illustrating a display example of guide information in the first embodiment;

FIG. 12B is a second view illustrating a display example of the guide information in the first embodiment;

FIG. 12C is a third view illustrating a display example of the guide information in the first embodiment;

FIG. 12D is a fourth view illustrating a display example of the guide information in the first embodiment;

FIG. 13A is a first view illustrating an example of imaging of a second photographed image;

FIG. 13B is a second view illustrating an example of imaging of the second photographed image;

FIG. 14A is a first view illustrating another display example of the guide information in the first embodiment;

FIG. 14B is a second view illustrating another display example of the guide information in the first embodiment;

FIG. 15A is a first view illustrating change of angle;

FIG. 15B is a second view illustrating change of angle;

FIG. 16 is a diagram illustrating an example of guide information in a second embodiment;

FIG. 17A is a first view illustrating change of the guide information;

FIG. 17B is a second view illustrating change of the guide information;

FIG. 18A is a first view illustrating another example of the guide information in the second embodiment; and

FIG. 18B is a second view illustrating another example of the guide information in the second embodiment.

### DETAILED DESCRIPTION OF THE INVENTION

Embodiments of the present invention will be explained hereinafter with reference to the drawings.

### First Embodiment

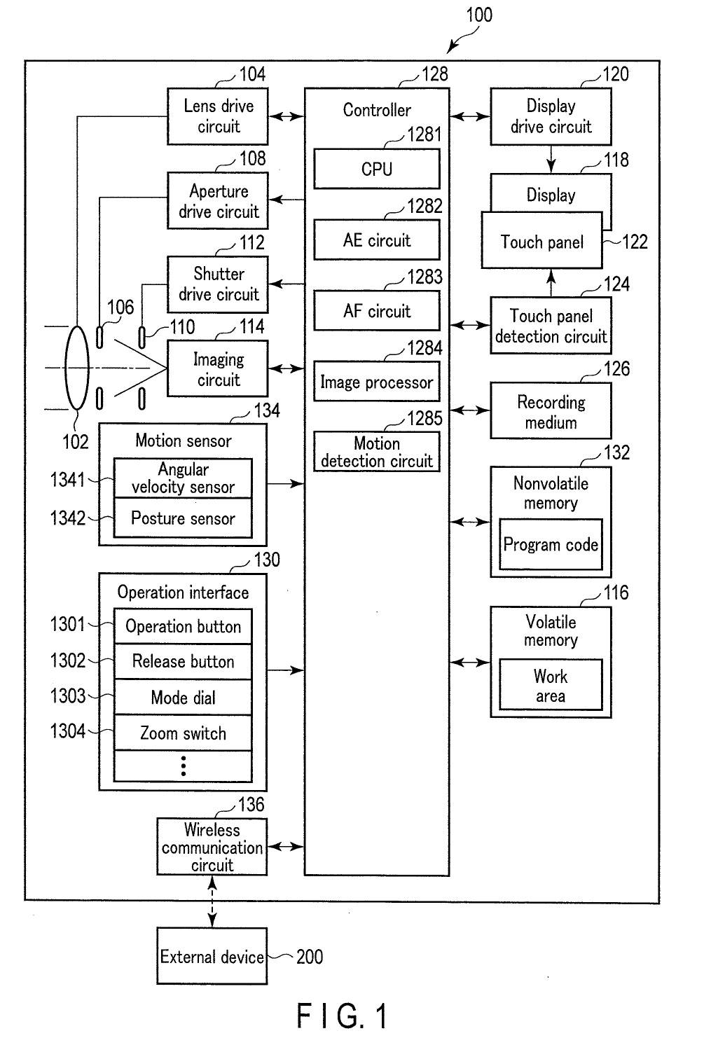

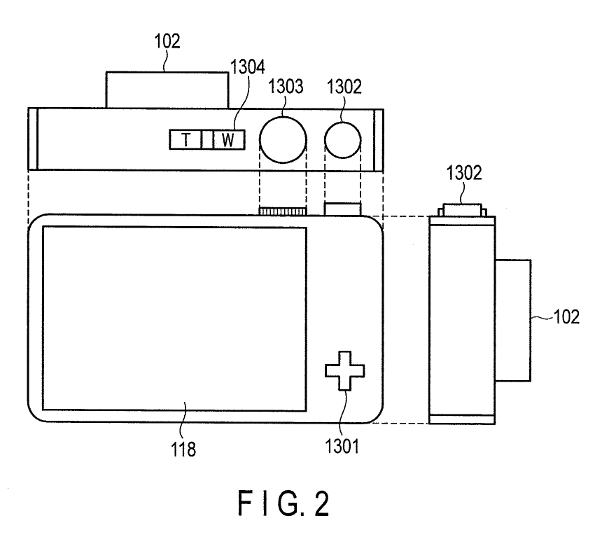

A first embodiment of the present invention will be explained hereinafter. FIG. 1 is a diagram illustrating a configuration serving as an example of an imaging apparatus according to embodiments of the present invention. FIG. 2 is an external view of the imaging apparatus serving as the example.

An imaging apparatus 100 illustrated in FIG. 1 includes an imaging lens 102, a lens drive circuit 104, an aperture 106, an aperture drive circuit 108, a shutter 110, a shutter drive circuit 112, an imaging circuit 114, a volatile memory 116, a display 118, a display drive circuit 120, a touch panel 122, a touch panel detection circuit 124, a recording medium 126, a controller 128, an operation interface 130, a nonvolatile memory 132, a motion sensor 134, and a wireless communication circuit 136.

The imaging lens 102 is an optical system to guide an imaging light beam from a subject (not illustrated) onto a light-receiving surface of the imaging circuit 114. The imaging lens 102 includes a plurality of lenses such as a focus lens, and may be formed as a zoom lens. The lens drive circuit 104 includes a motor and a drive circuit thereof and the like. The lens drive circuit 104 drives various types of lenses forming the imaging lens 102 in its optical axis direction (direction of a long-dash-short-dash line in the drawing), in accordance with control of a CPU 1281 in the controller 128.

The aperture 106 is configured to be openable and closable, to adjust the amount of the imaging light beam made incident on the imaging circuit 114 through the imaging lens 102. The aperture drive circuit 108 includes a drive circuit to drive the aperture 106. The aperture drive circuit 108 drives the aperture 106 in accordance with control of the CPU 1281 in the controller 128.

The shutter 110 is configured to change the light-receiving surface of the imaging circuit 114 to a light shielding state or an exposure state. The shutter 110 adjusts the exposure time of the imaging circuit 114. The shutter drive circuit 112 includes a drive circuit to drive the shutter 110, and drives the shutter 110 in accordance with control of the CPU 1281 in the controller 1281.

The imaging circuit 114 includes the light-receiving surface on which an imaging light beam from the subject that is condensed through the imaging lens 102 is imaged. The light-receiving surface of the imaging circuit 114 is formed by arranging a plurality of pixels in a two-dimensional manner, and a light-incident side of the light-receiving surface is provided with a color filter. The imaging circuit 114 as described above converts an image (subject image) corresponding to the imaging light beam imaged on the light-receiving surface into an electrical signal (hereinafter referred to as “image signal”) corresponding to the light quantity thereof. The imaging circuit 114 subjects the image signal to analog processing such as CDS (Correlated Double Sampling) and AGC (Automatic Gain Control), in accordance with control of the CPU 1281 in the controller 128. In addition, the imaging circuit 114 converts the image signal subjected to analog processing into a digital signal (hereinafter referred to as “image data”).

The volatile memory 116 includes a work area as a storage area. The work area is a storage area provided in the volatile memory 116 to temporarily store data generated in the circuits of the imaging apparatus 100, such as image data acquired in the imaging circuit 114.

The display 118 is, for example, a liquid crystal display (LCD), and displays various images such as an image (live view image) for live view and images recorded on the recording medium 126. The display drive circuit 120 drives the display 118 based on the image data that is input from the CPU 1281 of the controller 128, to cause the display 118 to display the image.

The touch panel 122 is formed as one unitary piece on the display screen of the display 118, and detects a contact position of a user's finger or the like on the display screen. The touch panel detection circuit 124 drives the touch panel 122, and outputs a contact detection signal from the touch panel 122 to the CPU 1281 of the controller 128. The CPU 1281 detects a contact operation of the user on the display screen 128 from the contact detection signal, and executes processing corresponding to the contact operation.

The recording medium 126 is, for example, a memory card, and records an image file acquired by an imaging operation. The image file is a file formed by providing a predetermined header to image data acquired by an imaging operation. The image file may record model image data and guide information, as well as the image data acquired by an imaging operation. The model image data is image data of other imaging conditions that is generated based on the image data imaged by the user's intention. The imaging conditions herein include, for example, conditions of changing (framing) the composition. The guide information is information to guide imaging, when the user wishes to image an image similar to a model image. For example, when the model image data is generated by changing the framing conditions, the guide information is information to cause the user to recognize the moving direction of the imaging apparatus 100 required for imaging an image similar to the model image.

The controller 128 is a control circuit to control operations of the imaging apparatus 100, and includes the CPU 1281, an AE circuit 1282, an AF circuit 1283, an image processor 1284, and a motion detection circuit 1285.

The CPU 1281 controls operations of blocks outside the controller 128, such as the lens drive circuit 104, the aperture drive circuit 108, the shutter drive circuit 112, the imaging circuit 114, the display drive circuit 120, and the touch panel detection circuit 124, and controls operations of the control circuits inside the controller 128. The CPU 1281 also performs processing to generate the guide information described above. The details of the processing of generating the guide information will be explained later.

The AE circuit 1282 controls AE processing. More specifically, the AE circuit 1282 calculates subject luminance using the image data acquired by the imaging circuit 114. The CPU 1281 calculates the aperture amount (aperture value) of the aperture 106 in exposure, the opening time (shutter speed value) of the shutter 110, and the sensitivity of the imaging element, and the like, in accordance with the subject luminance.

The AF circuit 1283 detects the focal state in the imaging screen, and controls AF processing. More specifically, the AF circuit 1283 evaluates the contrast of the image data in accordance with an AF evaluation value calculated from the image data, and controls the lens drive circuit 104 to cause the focus lens to change to a focused state. Such AF processing is referred to as the contrast method. A phase-difference method may be used as AF processing.

The image processor 1284 performs various types of image processing on the image data. Examples of the image processing include white balance correction, color correction, gamma (y) correction, enlargement and reduction processing, and compression, and the like. The image processor 1284 also performs expansion processing on the compressed image data. The image processor 1284 also performs processing to generate the model image data described above. The details of processing to generate model image data will be explained later.

The motion detection circuit 1285 detects movement of the imaging apparatus 100. Movement of the imaging apparatus 100 is detected by, for example, motion vector detection using image data of a plurality of frames, or based on output of the motion sensor 134.

The operation interface 130 includes various types of operation interfaces operated by the user. The operation interface 130 includes, for example, an operation button 1301, a release button 1302, a mode dial 1303, and a zoom switch 1304, and the like. The operation button 1301 is provided, for example, on the back surface of the imaging apparatus 100, as illustrated in FIG. 2. The operation button 1301 is used as an operation interface to select and determine an item on the menu picture, for example. The release button 1302 is, for example, provided on an upper surface of the imaging apparatus 100, as illustrated in FIG. 2. The release button 1302 is an operation interface to issue an instruction to photograph a still image. The mode dial 1303 is provided, for example, on the upper surface of the imaging apparatus 100, as illustrated in FIG. 2. The mode dial 1303 is an operation interface to select an imaging setting of the imaging apparatus 100. The image setting is, for example, setting of the operation mode. The operation mode includes a normal imaging mode and a composition guide mode. The normal imaging mode is a mode in which imaging is performed in a state without display of guide information. In the normal imaging mode, imaging is performed by a conventionally known method, such as aperture priority imaging, shutter priority imaging, program imaging, and manual imaging. By contrast, the composition guide mode is a mode in which imaging is performed in a state with display of guide information. The zoom switch 1304 is a switch to perform a zooming operation by the user.

The nonvolatile memory 132 stores program codes to execute various types of processing with the CPU 1281. The nonvolatile memory 132 also stores various control parameters, such as control parameters necessary for operations of the imaging lens 102, the aperture 106, and the imaging circuit 114, and the like, and control parameters necessary for image processing in the image processor 1284.

The motion sensor 134 includes an angular velocity sensor 1341 and a posture sensor 1342. The angular velocity sensor 1341 is, for example, a gyro sensor, and detects angular velocity around three axes generated in the imaging apparatus 100. The posture sensor 1342 is, for example, a triaxial acceleration sensor, and detects acceleration generated in the imaging apparatus 100.

The wireless communication circuit 136 is, for example, a wireless LAN communication circuit, and performs processing in communications between the imaging apparatus 100 and the external device 200. The external device 200 is, for example, a smartphone.

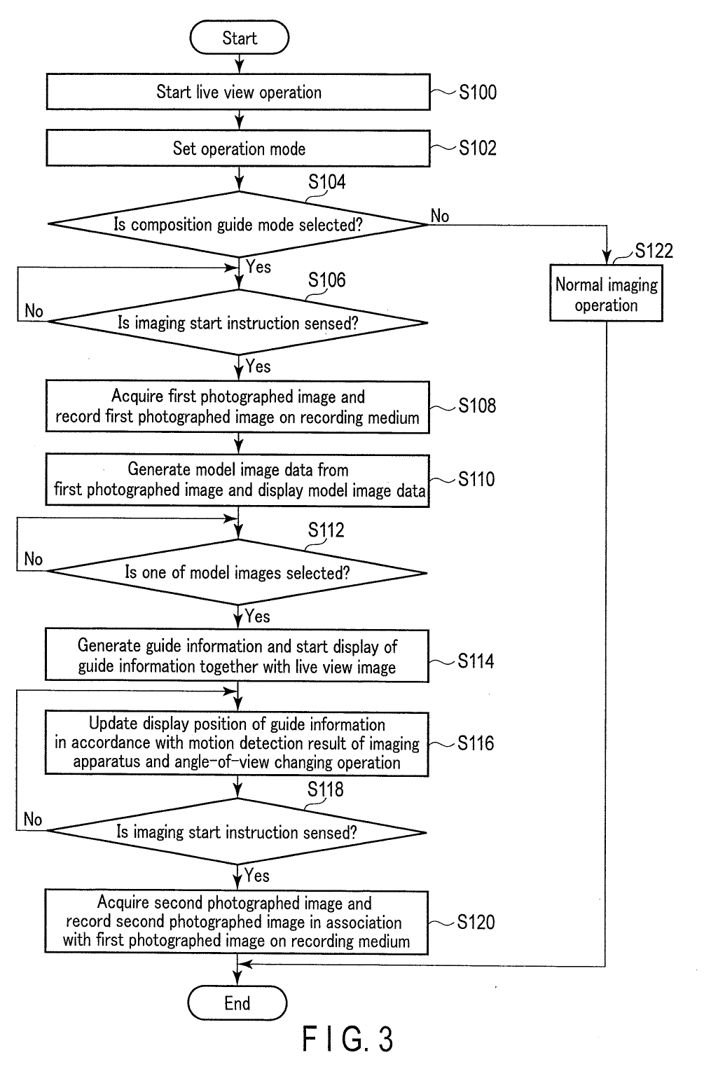

The following is explanation of an imaging method using the imaging apparatus 100 according to the present embodiment. FIG. 3 is a flowchart illustrating a process of the imaging method according to the present embodiment. The process of FIG. 3 is controlled by the CPU 1281 of the control circuit 128. The process of FIG. 3 is based on the premise that the mode of the imaging apparatus 100 is set to the imaging mode. The imaging apparatus 100 may have modes other than the imaging mode, such as a playback mode to play back image data.

The process of FIG. 3 is started, for example, when the power of the imaging apparatus 100 is turned on. When the process of FIG. 3 is started, the CPU 1281 starts a live view operation (Step S100). Specifically, the CPU 1281 causes the imaging circuit 114 to continuously operate, processes live view image data acquired by a continuous operation of the imaging circuit 114 in the image processor 1284, and thereafter inputs the processed live view image data to the display drive circuit 120. The display drive circuit 120 displays the imaging result of the imaging circuit 114 in real time on the display 118, based on the input live view image data. The user can check the composition and the like, by viewing the live view images displayed by the live view operation.

During the live view operation, the user selects the operation mode of the imaging apparatus 100 (Step S102). The operation mode is selected, for example, by an operation of the operation button 1301 or an operation of the touch panel 122. After selection of the operation mode, the CPU 1281 determines whether the composition guide mode is selected as the operation mode (Step S104).

When it is determined that the composition guide mode is selected as the operation mode in Step S104, the CPU 1281 determines whether an imaging start instruction is sensed as a first instruction (Step S106). The imaging start instruction is, for example, an operation of pushing the release button 1302, or a touch release operation using the touch panel 122. The CPU 1281 waits until an imaging start instruction is sensed in Step S106. The process may return to Step S100, when a predetermined time passes without sense of an imaging start instruction.

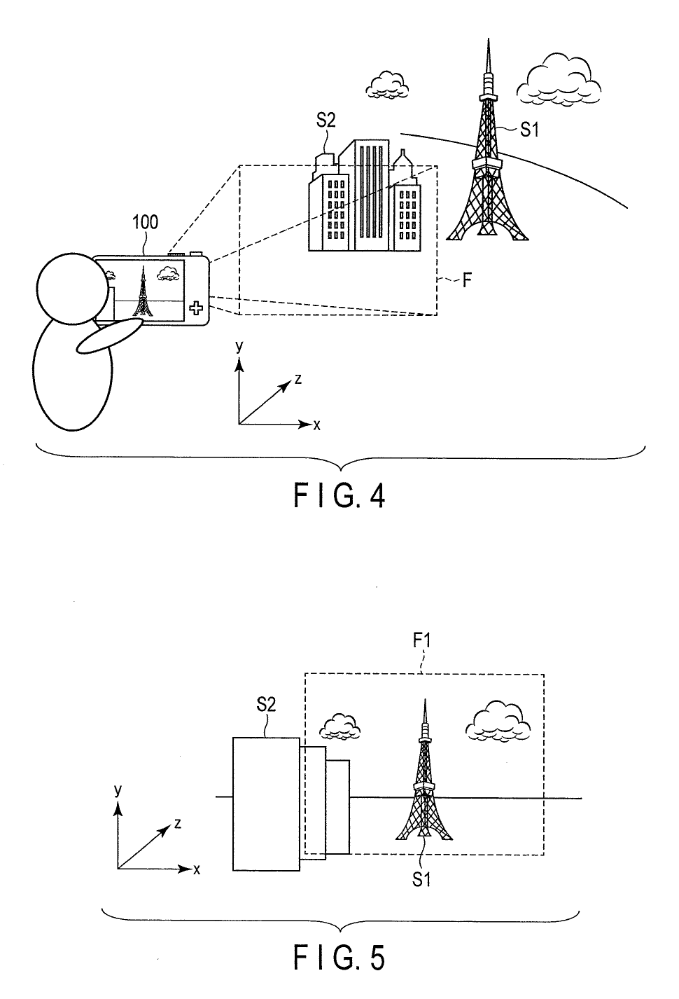

FIG. 4 illustrates an example of check in the composition guide mode. In the composition guide mode, the user who is holding the imaging apparatus 100 finds a desired composition while moving the imaging apparatus 100 in x, y, and z directions. The desired composition indicates a state in which the subject (for example, a subject S1) that the user is going to photograph is disposed in a position desired by the user in an angle of view F1 of the imaging apparatus 100, as illustrated in FIG. 5. The z direction is a direction along the optical axis of the imaging apparatus 100. The x direction is a plane direction perpendicular to the optical axis, and parallel with the earth's surface. The y direction is a plane direction perpendicular to the optical axis, and perpendicular to the earth's surface.

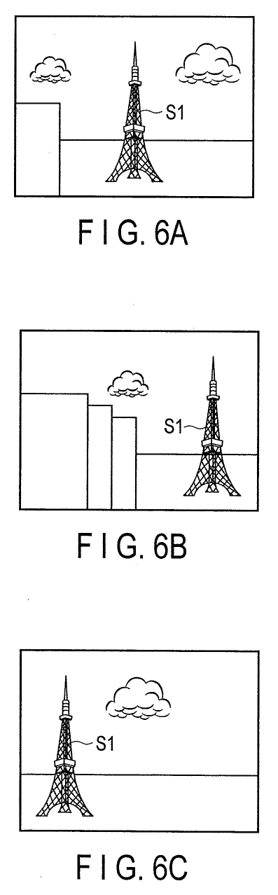

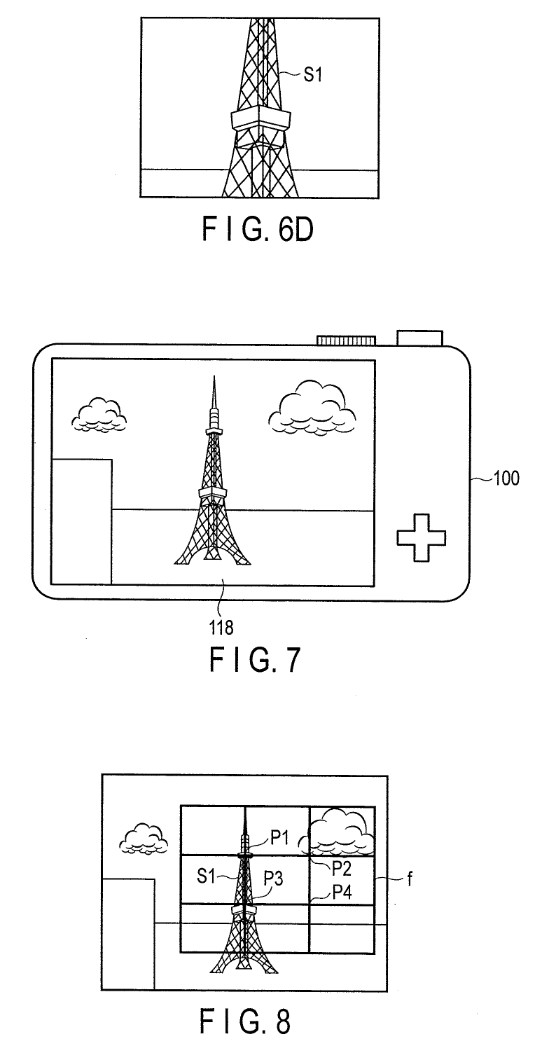

FIG. 6A to FIG. 6D illustrate change of the composition, that is, a concept of framing. For example, in the state where the subject S1 is located around the center of the angle of view F1 as illustrated in FIG. 6A, when the user moves the imaging apparatus 100 in the −x direction, the subject S1 is moved in the +x direction in the angle of view F1 as illustrated in FIG. 6B. In the state of FIG. 6A, when the user moves the imaging apparatus 100 in the +x direction, the subject S1 is moved in the −x direction in the angle of view F1 as illustrated in FIG. 6C. In addition, in the state of FIG. 6A, when the user moves the imaging apparatus 100 in the +z direction or performs a zooming operation on the telephoto side, the subject S1 is enlarged as illustrated in FIG. 6D. As described above, the subject S1 can be disposed in a predetermined position in the angle of view, by moving the imaging apparatus 100 by the user.

With the framing as described above, the user changes other imaging conditions including imaging parameters such as the aperture and the shutter speed, and image processing parameters such as white balance setting, if necessary. When the desired imaging conditions are set, the user issues an imaging start instruction as a first instruction. For example, suppose that the user issues an imaging start instruction in the composition illustrated in FIG. 7 (corresponding to FIG. 6A).

When it is determined that an imaging start instruction is sensed in Step S106, the CPU 1281 suspends the live view operation, and starts an imaging operation by the imaging circuit 114. In the imaging operation, the CPU 1281 operates the imaging circuit 114 in accordance with imaging parameters set by the user, and acquires image data (first photographed image data) as a first photographed image. Thereafter, the CPU 1281 processes the first photographed image data in the image processor 1284, and records the processed first photographed image data on the recording medium 126 (Step S108).

After the imaging operation, the CPU 1281 generates at least one piece of model image data from the first photographed image data with the image processor 1284. Thereafter, the CPU 1281 inputs the first photographed image data and the model image data to the display drive circuit 120, and displays the first photographed image based on the first photographed image data and a model image based on the model image data on the display 118 (Step S110).

The processing in Step S110 will be further explained hereinafter. FIG. 8 illustrates a concept of generation of model image data for framing. The model image data for framing means image data supposed to be acquired with framing different from the framing at the time when the first photographed image data is acquired. Such model image data is acquired by trimming the image data in a composition frame f by the image processor 1284 in the state where the subject is disposed in a predetermined position in the composition frame f set in the first photographed image data. The subject is, for example, a subject in the focus position. The composition frame f is formed of, for example, trisection lines in the horizontal direction and the vertical direction, and has a predetermined aspect ratio.

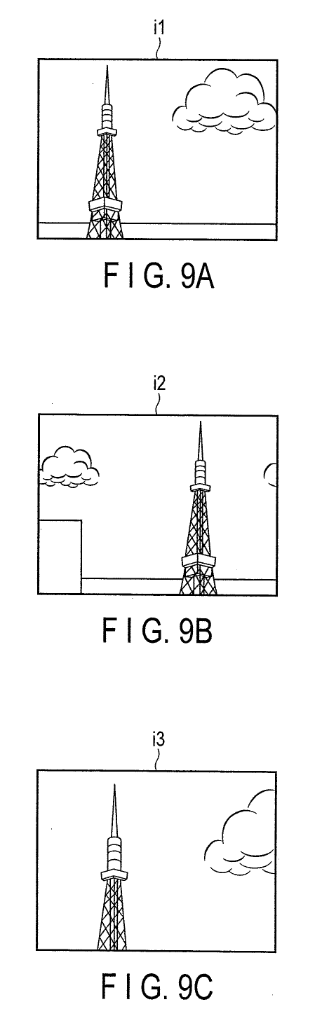

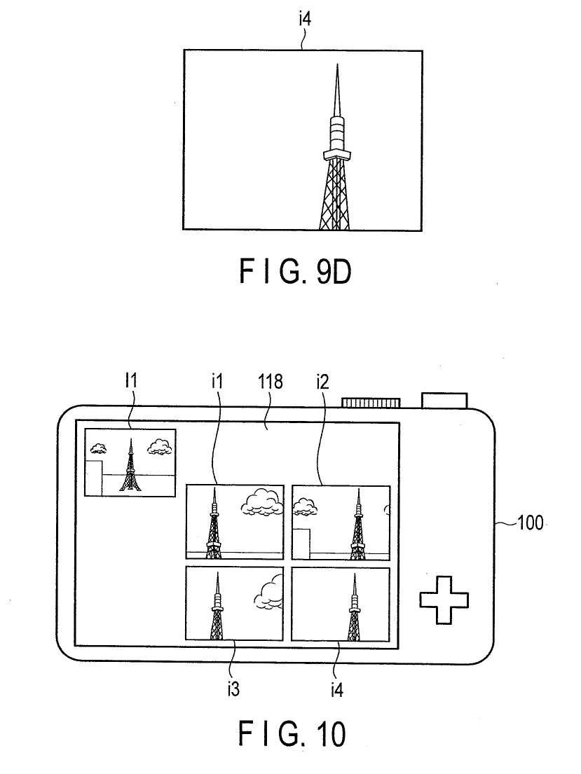

Trimming is performed on the image data in the state where the subject is disposed, for example, in intersection points P1, P2, P3, and P4 of the trisection lines. When trimming is performed in the state where the subject is disposed at the point P1, model image data i1 illustrated in FIG. 9A is generated. When trimming is performed in the state where the subject is disposed at the point P2, model image data i2 illustrated in FIG. 9B is generated. When trimming is performed in the state where the subject is disposed at the point P3, model image data i3 illustrated in FIG. 9C is generated. When trimming is performed in the state where the subject is disposed at the point P4, model image data i4 illustrated in FIG. 9D is generated. For example, reduction processing for display is also performed on the model image data generated as described above. For example, reduction processing for display is also performed on the first photographed image data.

In the present embodiment, trisection lines are used for generating model image data. However, the method for generating model image data is not limited thereto. For example, a frame formed of generally known composition lines such as golden section lines and triangular composition lines may be used as the composition frame f. The aspect ratio of the region to be trimmed may be an aspect ratio generally used for photographs, such as 16:9, 3:2, and 1:1.

In the present embodiment, the subject is a subject in the focus position. However, the subject may be determined using a well-known feature extraction technique, such as face detection, instead of determining the subject according to the focus position.

FIG. 10 is a diagram illustrating a display example of the first photographed image and the model images. In the example, as illustrated in FIG. 10, a reduced image I1 of the first photographed image is displayed in an upper left end portion of the screen of the display 118 (touch panel 122), and reduced images i1 to i4 of a plurality of model images are displayed in a tiled manner in the lower left portion of the screen. Displaying the first photographed image and the model images simultaneously causes the user to perceive variations of framing.

In the present embodiment, reduced images of the model images are displayed in a tiled manner, but the method for displaying the model images is not limited thereto. For example, when the number of model images is large, only some of the model images may be displayed, and display may be switched to display of other model images when a predetermined time passes or by a user's operation. In addition, the first photographed image and the model images may be displayed such that their image regions overlap or image regions of the model images overlap. In addition, the images may be displayed one by one on the whole screen of the display 118, without reducing the images. In this case, the images are successively displayed when a predetermined time passes or by a user's operation.

In the present embodiment, a plurality of pieces of model image data are generated from the first photographed image data, but only one piece of model image data may be generated. In this case, determination in the following Step S112 is unnecessary.

FIG. 3 will be explained hereinafter again. After display as illustrated in FIG. 10 is performed, the user selects a desired model image. The selection serving as a second instruction is performed by, for example, an operation of the operation button 1301 or an operation of the touch panel 122. During user's selection of a model image, the CPU 1281 determines whether any of the model images has been selected by the user (Step S112). The CPU 1281 waits until a model image is selected in Step S112. The process may move to Step S118 when it is determined that no model image is selected.

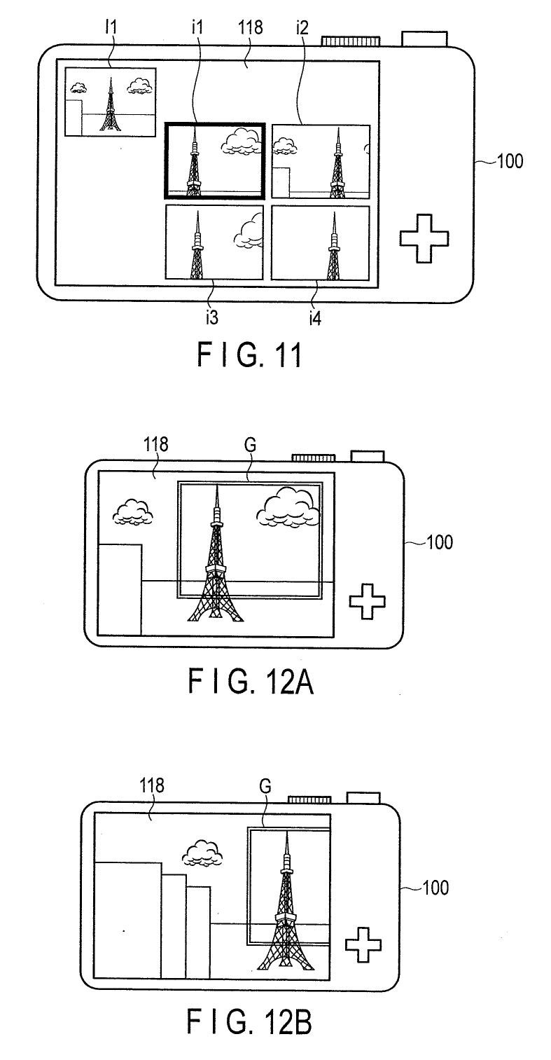

When it is determined in Step S112 that a model image is selected, the CPU 1281 controls the display drive circuit 120 to display the selected model image enclosed with a thick frame, for example, as illustrated in FIG. 11. FIG. 11 illustrates a display example when the model image i1 is selected. After display with a thick frame, the CPU 1281 generates guide information corresponding to the selected model image i1. After generation of guide information, the CPU 1281 resumes the live view operation. Thereafter, the CPU 1281 inputs the guide information to the display drive circuit 120, and causes the display 118 to display the guide information together with the live view image (Step S114).

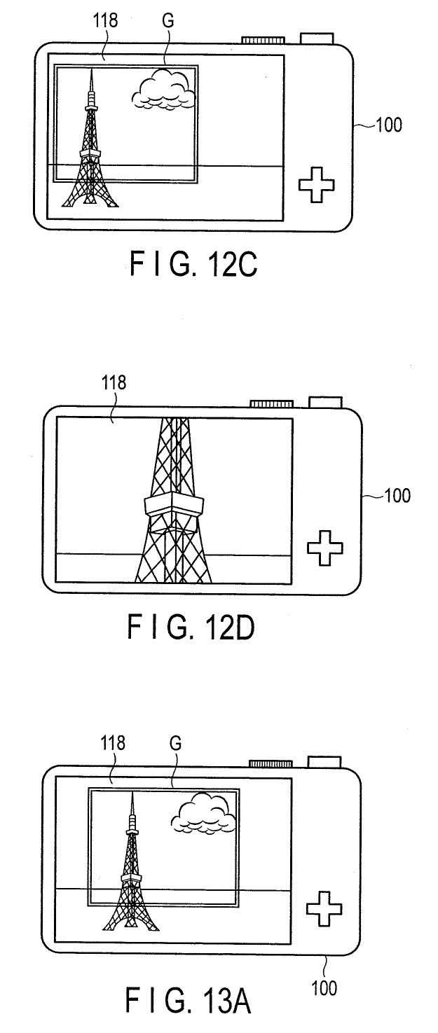

The processing in Step S114 will be explained hereinafter. As an example, the processing to display guide information for framing will be explained. First, the CPU 1281 resumes the live view operation, to acquire live view image data. Thereafter, the CPU 1281 calculates a matching region between the acquired live view image data and the selected model image data. A well-known technique such as template matching may be used as a method for searching the matching region between image data. After calculation of the matching region, the CPU 1281 generates guide information based on the matching region. Specifically, the CPU 1281 determines coordinates of the matching region in the live view image data corresponding to the model image data, as the guide information. Thereafter, the CPU 1281 inputs the guide information to the display drive circuit 120, to display the guide information. FIG. 12A to FIG. 12D illustrate display examples of the guide information. As illustrated in FIG. 12A to FIG. 12D, display of guide information is display to cause the user to recognize the position of the model image in the live view image, and performed by displaying, for example, a frame image G indicating the region of the model image.

FIG. 3 will be explained hereinafter again. While the guide information G is displayed, the CPU 1281 detects movement of the imaging apparatus 100 with the motion detection circuit 1285. The CPU 1281 changes the display position of the guide information G in accordance with movement of the imaging apparatus 100. The CPU 1281 also detects a zooming operation performed by the user, and issues an instruction to the lens drive circuit 104 to change the focal length of the imaging lens 102 in accordance with the detected zooming operation. The CPU 1281 changes the display position of the guide information G, in response to change of the angle of view of the live view image with the change of the focal length (Step S116).

While the guide information G is displayed, the user finds a desired composition while moving the imaging apparatus 100 in the x, y, and z directions, with reference to the guide information G. For example, FIG. 12A illustrates guide information G displayed directly after the first photographed image is acquired. When the user moves the imaging apparatus 100 in this state, the coordinates of the matching region in the live view image data corresponding to the model image data change. Accordingly, as illustrated in FIG. 12B to FIG. 12D, the display position of the guide information G also changes. FIG. 12B illustrates a display state of the guide information in the case where the user moves the imaging apparatus 100 in the −x direction, FIG. 12C illustrates a display state of the guide information in the case where the user moves the imaging apparatus 100 in the +x direction, and FIG. 12D illustrates a display state of the guide information in the case where the user moves the imaging apparatus 100 in the +z direction or the user performs a zooming operation on the telephoto side. As illustrated in FIG. 12D, no guide information G is displayed, when no coordinates of the matching region corresponding to the model image data exist in the live view image data. As described above, the guide information in the present embodiment indicates a framing state of the model image. Accordingly, even when the live view image is changed by framing, the guide information G is displayed as if the guide information G was stuck on the subject.

In the same manner as the time of imaging the first photographed image, the user may change other imaging conditions including imaging parameters such as the aperture value and the shutter speed, and image processing parameters such as white balance setting, if necessary, together with change of framing.

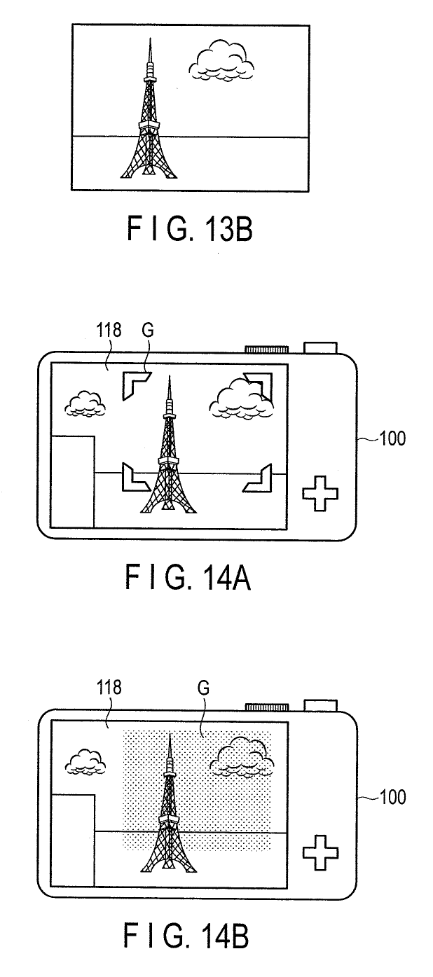

FIG. 3 will be explained hereinafter again. After change of the display position of the guide information G, the CPU 1281 determines whether an imaging start instruction is sensed (Step S118). The imaging start instruction is, for example, an operation of pushing the release button 1302, or a touch release operation using the touch panel 122, in the same manner as described above. In the same manner as imaging of the first photographed image, the user issues an imaging start instruction when desired imaging conditions are satisfied while operating the imaging apparatus 100. For example, suppose that the user obtains a perception “approaching the subject to remove obstructive background” with respect to framing, from the guide information G in FIG. 12C. In this case, the user resets framing as illustrated in FIG. 13A to image the whole image of the subject that the user wishes to image, and issues an imaging start instruction.

When it is determined that no imaging start instruction is sensed in Step S118, the CPU 1281 returns the process to Step S116. When it is determined that an imaging start instruction is sensed in Step S118, the CPU 1281 starts an imaging operation with the imaging circuit 114. In the imaging operation, the CPU 1281 operates the imaging circuit 114 in accordance with imaging parameters that are set by the user, and acquires image data (second photographed image data) serving as a second photographed image. Thereafter, the CPU 1281 processes the second photographed image data in the image processor 1284, and records the processed second photographed image data as an image file associated with the first photographed image data on the recording medium 126 (Step S120). Thereafter, the CPU 1281 ends the process in FIG. 3. By the imaging operation as described above, the second photographed image as illustrated in FIG. 13B is recorded on the recording medium 126. The second photographed image illustrated in FIG. 13B is an image imaged by the user by performing framing with reference to the model images.

In Step S104, when it is determined that the composition guide mode is not set as the operation mode, that is, the normal imaging mode is set, the CPU 1281 performs processing of the normal imaging mode (Step S122). The processing of the normal imaging mode is the same as a conventional imaging mode, and will be briefly explained hereinafter. Specifically, when the user issues an imaging start instruction, the CPU 1281 operates the imaging circuit 114 in accordance with imaging parameters that are set by the user, to acquire photographed image data. Thereafter, the CPU 1281 processes the photographed image data in the image processor 1284, and records the processed photographed image data as an image file on the recording medium 126. After the processing of the normal imaging mode, the CPU 1281 ends the process of FIG. 3.

As described above, according to the first embodiment, model images generated from the first photographed image that is imaged by the user with an intention are presented to the user. This structure enables the user to obtain a perception with respect to framing, for example, by comparing the first photographed image with the model images. In addition, the guide information corresponding to the model image selected by the user is displayed together with the live view image on the display 118. This structure enables the user to reflect the perception obtained with the model image in the next photographing. This structure enables improvement of the user's photographing technique.

The first embodiment described above illustrates the example of generating guide information for framing based on the matching region between image data. By contrast, guide information for framing may be generated, by detecting the change amount of the posture of the imaging apparatus 100 during display of the live view image before imaging of the second photographed image with the motion sensor 134. The guide information is obtained by converting the change amount of the posture detected with the motion sensor 134 into a movement amount on the image.

In the first embodiment described above, a frame image indicating the region of the model image is displayed as the guide information for framing. By contrast, instead of the frame image, for example, a frame image G may be displayed in only corner portions of the region of the model image, as illustrated in FIG. 14A. As another example, the frame image G may be displayed in a semitransparent state as illustrated in FIG. 14B. The method for displaying the guide information for framing may be variously modified as described above.

The guide information may be displayed only for a predetermined time from display of the live view image before imaging of the second photographed image.

In addition, the model image data generated in the first embodiment described above is image data with a composition different from that of the first photographed image data. However, the method for generating the model image data is not limited thereto. For example, the model image data may be generated also with a change relating to picture taking, such as white balance, as well as change of composition.

In the first embodiment described above, the model images are displayed on the display 118 of the imaging apparatus 100.

By contrast, in Step S110 of FIG. 3, the first photographed image data may be transmitted to the external device 200 through the wireless communication circuit 136, to prepare model image data in the external device 200 and display the model images on the display of the external device 200. In this case, guide information is displayed in the same manner as the first embodiment described above, in accordance with the model image selected from the model images displayed on the display of the external device 200.

### Second Embodiment

Next, a second embodiment of the present invention will be explained hereinafter. Explanation of constituent elements of the second embodiment that are the same as those in the first embodiment is omitted. Specifically, because the configuration of the imaging apparatus 100 of the second embodiment is the same as that of the first embodiment, and explanation thereof is omitted. In addition, because the process of the flowchart illustrated in FIG. 3 is basically applicable to the process of the imaging method according to the present embodiment, explanation of the imaging method is also omitted.

In the second embodiment, model image data for change of angle (rotation in the pitch direction) for the subject is generated. FIG. 15A and FIG. 15B are diagrams illustrating change of angle. Change of angle in the present embodiment indicates changing the state in which the optical axis of the imaging apparatus 100 is directed in a direction horizontal to the Earth's surface as illustrated in FIG. 15A to a state in which the optical axis of the imaging apparatus 100 is inclined with respect to the Earth's surface (the state in which the imaging apparatus 100 is moved in the pitch direction) as illustrated in FIG. 15B.

The model image data as illustrated in FIG. 15B is generated by, for example, performing projective transformation on each region of the first photographed image data. Specifically, image data corresponding to image data obtained by rotating the first photographed image data by a predetermined rotation angle in the pitch direction is generated by projective transformation. The rotation angle is a rotation angle in the pitch direction based on the state in which the imaging apparatus 100 is horizontally disposed. Model images are displayed as illustrated in Step S110 of FIG. 3, based on the model image data generated as described above.

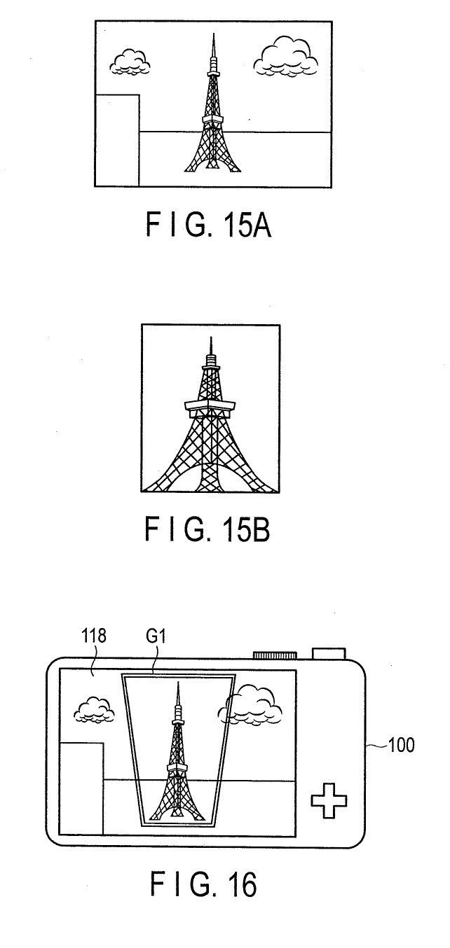

When a model image is selected, guide information is displayed on the display 118 also in the second embodiment, in the same manner as the first embodiment. FIG. 16 is an example of guide information in the second embodiment. In the second embodiment, a rectangular image G1 corresponding to change of angle for the model image is displayed as the guide information on the display 118, as illustrated in FIG. 16. The length of the short side of a trapezoid illustrated in FIG. 16 is determined in accordance with a difference between the rotation angle of the selected model image data and the rotation angle (change in posture in the pitch direction) of the imaging apparatus 100 in display of the live view image. Specifically, the length of the short side decreases as the difference in rotation angle increases.

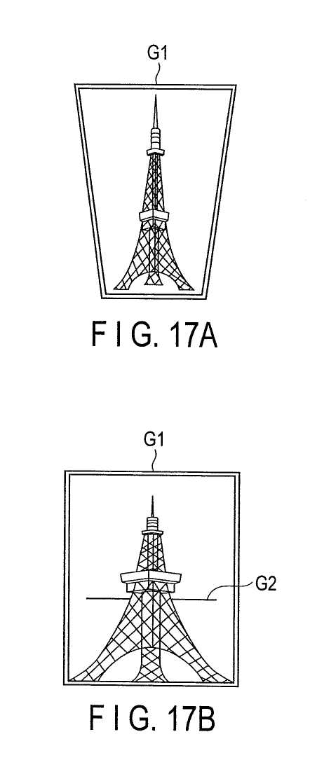

FIG. 17A and FIG. 17B illustrate change of the guide information. For example, FIG. 17A illustrates guide information displayed when the imaging apparatus 100 is held horizontally with respect to the Earth's surface. In this state, the guide information G1 has a trapezoidal shape, because a large difference exists between the rotation angle obtained by the model image selected by the user and the rotation angle of the imaging apparatus 100 in display of the live view image. By contrast, when the imaging apparatus 100 is moved toward a direction in which the user looks up to the subject, the shape of the guide information G1 becomes close to a rectangular shape as illustrated in FIG. 17B, because of reduction in difference between the rotation angle obtained by the model image selected by the user and the rotation angle of the imaging apparatus 100 in display of the live view image. Imaging is performed in this state, and thereby an image equivalent to the image illustrated in FIG. 15B is imaged.

As described above, the present embodiment enables the user to obtain a perception with respect to change of angle, by comparing the first photographed image with the model images. In addition, because the guide information is displayed on the display 118 as in the present embodiment, the user is enabled to recognize the angle to photograph an image equivalent to the model image, as a bodily sensation, while viewing the live view image.

As the guide information, a rotation axis G2 of rotation to acquire the model image as illustrated in FIG. 17B may be displayed together, as well as the rectangular image G1.

The embodiment described above illustrates generation of model image data based on change of angle only in the pitch direction. By contrast, change of angle other than the pitch direction, that is, change of angle in the yaw direction may be considered.

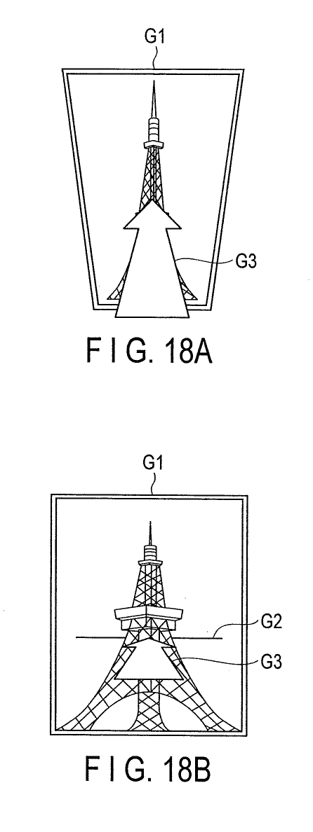

In addition, the method for indicating the degree of change of angle is not limited to change in shape of the rectangular image. For example, a normal line of a model image surface for the live view image may be displayed, or a rotation arrow corresponding to the angle change amount may be displayed. As another example, as illustrated in FIG. 18A and FIG. 18B, an arrow image G3 indicating a normal line of the model image surface may be displayed with change of the rectangular image G1. In this example, when the user moves the imaging apparatus 100 in a direction of looking up to the subject from a state in which the user holds the imaging apparatus 100 horizontally, the arrow image G3 is changed from the state of FIG. 18A to the state of FIG. 18B. Specifically, the arrow image G3 is changed in a perpendicular direction as viewed from the user.

What is claimed is:

1. An imaging apparatus comprising:
an imaging circuit configured to acquire image data from a subject image;
a display configured to display an image based on the image data;
an operation interface configured to provide an instruction to the imaging apparatus; and
a controller configured to cause the display to display a live view image based on image data acquired as live view image data by the imaging circuit, cause, when a first instruction serving as the instruction is provided from the operation interface, the imaging circuit to acquire the image data as first photographed image data, generate at least one piece of model image data based on the first photographed image data, generating guide information based on the generated model image data, and cause the display to display the generated guide information together with the live view image.

2. The imaging apparatus according to claim 1, wherein the controller further causes the display to display a model image based on the model image data, selects one of the model image data based on a second instruction serving as the instruction from the operation interface, generates the guide information based on the selected model image data, and causes the display to display the generated guide information together with the live view image.

3. The imaging apparatus according to claim 2, wherein the controller causes the display to also display a reduced image of the first photographed image data together, when causing the display to display the model image.

4. The imaging apparatus according to claim 2, wherein the controller generates image data supposed to be acquired with a framing different from framing in acquisition of the first photographed image data, as the model image data from the first photographed image data.

5. The imaging apparatus according to claim 1, further comprising:
a motion detection circuit configured to detect movement of the imaging apparatus,
wherein the guide information is displayed within the live view image, and
the controller changes a display position of the guide information in the live view image, in accordance with a detection result of the motion detection circuit.

6. The imaging apparatus according to claim 1, further comprising:
a motion detection circuit configured to detect change of angle of the imaging apparatus;
wherein the guide information is displayed within the live view image, and
the controller changes a shape of the guide information in the live view image, in accordance with a detection result of the motion detection circuit.

7. The imaging apparatus according to claim 1, wherein the model image data is acquired by trimming the first photographed image data, or performing projective transformation on the first photographed image data.

8. An imaging method comprising:
acquiring image data from a subject image with an imaging circuit;
causing a display to display a live view image based on image data acquired as live view image data with the imaging circuit;
causing the imaging circuit to acquire the image data as first photographed image data, when a first instruction is provided from an operation interface;
generating at least one piece of model image data based on the first photographed image data;
generating guide information based on the model image data; and
causing the display to display the guide information together with the live view image.
